(19) United States
(12) Patent Application Publication
(10) Pub. No.: US 2026/0219441 A1
(43) Pub. Date: Jul. 30, 2026

(54) HOLLOW CORE OPTICAL FIBREREFLECTOMETRY LAUNCH TAIL

(71) Applicant: Microsoft Technology Licensing, LLC, Redmond, WA (US)

(72) Inventors: Shahab BAKHTIARI GORAJOOBI, Southampton (GB); Eric Rodrigue NUMKAM FOKOUA, Southampton (GB); Seyed Reza SANDOGHCHI, Eastleigh (GB); Bence Ferenc MOCSAI, Southampton (GB)

(21) Appl. No.: 19/431,604

(22) Filed: Dec. 23, 2025

Related U.S. Application Data
(60) Provisional application No. 63/750,971, filed on Jan. 29, 2025.

(51) Int. Cl. G02B 6/02; G01M 11/00; G02B 1/11; G02B 6/25

(52) U.S. Cl. CPC G02B 6/02328; G01M 11/3109; G01M 11/3172; G02B 1/11; G02B 6/25

(57) ABSTRACT

A hollow core fiber launch tail for use in Optical Time Domain Reflectometry (OTDR) or Optical Frequency Domain Reflectometry (OFDR) measurements on hollow core fiber is described. The hollow core fiber launch tail comprises a length of hollow core fiber, having a first end and a second end; and coupling optics coupled to the first end of the length of hollow core fiber, wherein voids in the length of hollow core fiber are filled with a known gas.

### CROSS-REFERENCE TO RELATED APPLICATIONS

This application claims priority to, and the benefit of U.S. Provisional Application Number 63/750,971, filed Jan. 29, 2025, and entitled “HOLLOW CORE OPTICAL FIBREREFLECTOMETRY LAUNCH TAIL,” the entire contents of which are incorporated by reference herein in its entirety.

### BACKGROUND

Optical Time Domain Reflectometry (OTDR) and Optical Frequency Domain Reflectometry (OFDR) are methods used in fiber optic network testing, troubleshooting and optical fiber and cable manufacturing. OTDR and OFDR are primarily used to characterize the optical fiber by measuring the amount of light reflected back from different points along the fiber. Optical Time Domain Reflectometry is conveniently implemented using an apparatus known as an Optical Time Domain Reflectometer (also OTDR) and similarly Optical Frequency Domain Reflectometry is implemented using an apparatus known as an Optical Frequency Domain Reflectometer (also OFDR). OTDRs (the apparatus) are widely used by telecommunications companies, network operators, and technicians involved in the installation, maintenance, and repair of fiber optic networks. They play a crucial role in ensuring the performance and reliability of these networks by providing detailed information about the fiber's characteristics and detecting potential issues.

The basic principle of an OTDR involves sending a short pulse of light into the fiber and analyzing the reflected signals. By measuring the time it takes for the light to travel and the strength of the reflected signal, the OTDR can determine the distance to various events or anomalies in the fiber. The OTDR generates a graphical representation called an OTDR trace or trace graph, which displays the fiber's length and provides information about the optical loss, splice points, connectors, and any fiber breaks or bends. The trace graph helps technicians identify and locate faults or issues in the fiber optic network.

The embodiments described below are not limited to implementations which solve any or all of the disadvantages of known OTDR and/or OFDR methods and apparatus.

### SUMMARY

The following presents a simplified summary of the disclosure in order to provide a basic understanding to the reader. This summary is not intended to identify key features or essential features of the claimed subject matter nor is it intended to be used to limit the scope of the claimed subject matter. Its sole purpose is to present a selection of concepts disclosed herein in a simplified form as a prelude to the more detailed description that is presented later.

A hollow core fiber launch tail for use in Optical Time Domain Reflectometry (OTDR) or Optical Frequency Domain Reflectometry (OFDR) measurements on hollow core fiber is described. The hollow core fiber launch tail comprises a length of hollow core fiber, having a first end and a second end; and coupling optics coupled to the first end of the length of hollow core fiber, wherein voids in the length of hollow core fiber are filled with a known gas.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIGS. 1-4 show transverse cross-sectional views of different examples of hollow core fiber;

FIG. 5 shows an example OTDR trace graph generated using the apparatus of FIG. 6;

FIG. 6 is a schematic diagram of OTDR apparatus;

FIG. 7 is a schematic diagram showing an example test arrangement for OTDR or OFDR using a HCF launch tail;

FIG. 8 is a flow diagram of an example method of manufacturing a HCF launch tail;

FIG. 9A shows an example OTDR graph for three different HCF launch tails;

FIG. 9B shows an example OTDR graph where time-gating is used within the OTDR apparatus;

FIG. 10 is a graph of an example method of characterizing a HCF FUT using a HCF launch tail;

FIG. 11 shows an example OTDR graph for two different HCF launch tails;

FIG. 12 is a schematic diagram showing an example test arrangement for OFDR using a HCF launch tail;

FIG. 13 is a schematic diagram of a first example of OTDR apparatus that uses time-gating;

FIG. 14 is a schematic diagram of a second example of an OTDR apparatus that uses time-gating;

FIG. 15 shows an example method of performing OTDR on a FUT using the OTDR apparatus of FIG. 13 or 14.

Like reference numerals are used to designate like parts in the accompanying drawings.

### DETAILED DESCRIPTION

The detailed description provided below in connection with the appended drawings is intended as a description of the present examples and is not intended to represent the only forms in which the present examples are constructed or utilized. The description sets forth the functions of the examples and the sequence of operations for constructing and operating the examples. However, the same or equivalent functions and sequences may be accomplished by different examples.

As described above, OTDR may be used to characterize optical fibers. OTDR works by launching an optical probe pulse into a fiber (referred to as the fiber under test, FUT) and the width of the probe pulse determines the spatial resolution of the OTDR results. Pulse widths of a few nanoseconds (e.g. 2 ns) to a few microseconds (e.g. 3 μs) may be used. As the probe pulse propagates along the FUT, Rayleigh scattering gives rise to signals propagating in the opposite direction to the incident probe pulse. Rayleigh backscattering is caused by the interaction of the incident light with refractive index fluctuations in the FUT (e.g. in the core of the FUT). The backscattered signals are then redirected into a photodetector (PD). The time delay at which a signal is detected can be related to the position in the FUT where it was generated by knowing the speed of light in the FUT. Then, an OTDR trace can be constructed by plotting the power of the backscattered light (as detected by the PD) vs. position along the fiber.

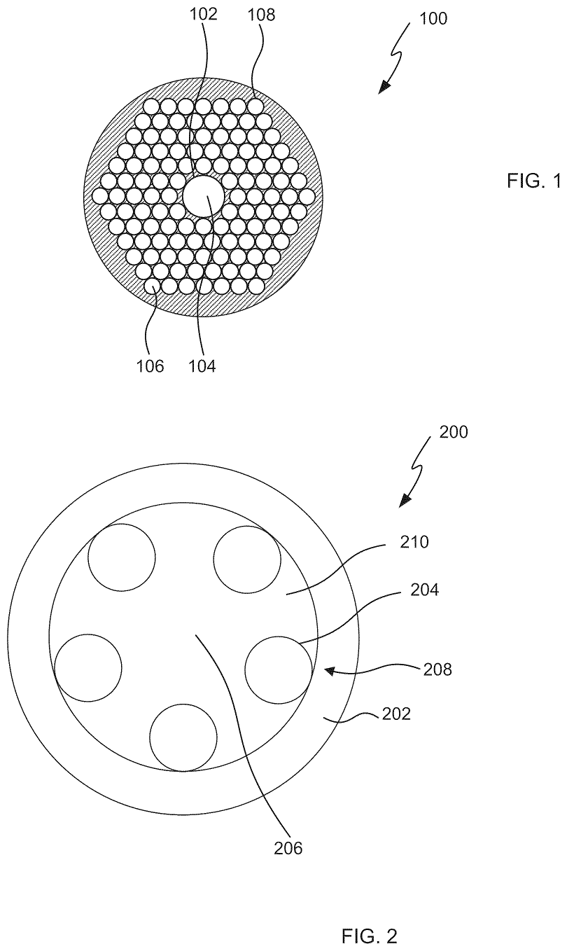

OTDR is widely used to identify fiber breaks, flaws or other anomalies in the fiber in optical networks; however, conventional OTDR techniques are not suitable for analyzing network links that include hollow core fiber (HCF). In standard optical fiber (e.g. single mode fiber, SMF, or multimode fiber, MMF), there is a solid core (typically made of glass) in which the light travels and the guidance of the light relies upon the cladding material that surrounds the core having a lower refractive index than the core material. In HCF the light does not travel in a solid core, but instead the light travels in a hollow core which may be filled with air and different guidance mechanisms are used. Two types of HCF that use different guidance mechanisms are hollow core photonic bandgap fibers (PBGFs) and antiresonant hollow core fibers (ARFs) and these are described in more detail below with reference to FIGS. 1-4.

FIG. 1 shows a transverse cross-sectional view of an example hollow core PBGF 100. The fiber 100 comprises a central void area 102 with a hollow core 104 and a cladding comprising a plurality of smaller tubular hollow structures 106, 108 arranged uniformly. The longitudinal axes of the central tube 102 and the smaller tubular structures 106, 108 are substantially parallel.

FIGS. 2-4 show transverse cross-sectional views of three different examples of antiresonant hollow core fibers (ARFs). Light is guided in these fibers by an antiresonant optical effect. Each of the fibers 200, 300, 400 comprises a tubular outer cladding (or jacket) 202, a structured, inner, cladding comprising a plurality of tubular cladding capillaries 204, 304, 404 and a hollow core 206. The outer cladding 202 has a glass thickness that is typically much larger than the cladding capillaries 204, 304, 404. In the first example, shown in FIG. 2, the structured, inner, cladding comprises five capillaries 204 of the same cross-sectional size and shape, which are arranged inside the outer cladding 202 in a single ring so that the longitudinal axes of each cladding capillary 204 and of the outer cladding 202 are substantially parallel. Each cladding capillary 204 is in contact with (e.g. bonded to) the inner surface of the outer cladding 202 at an azimuthal location 108, such that the cladding capillaries 204 are evenly spaced around the inner circumference of the outer cladding 202, and are also spaced apart from each other by gaps 210 (i.e. such that there is no contact between neighbouring capillaries). In some designs of ARF, the cladding capillaries 204 may be positioned in contact with each other (in other words, not spaced apart as in FIG. 2), but spacing to eliminate this contact can improve the fiber's optical performance. The gaps 210 removes nodes that arise at the contact points between adjacent tubes and which tend to cause undesirable resonances that result in high losses. Accordingly, fibers with spaced-apart cladding capillaries may be referred to as “nodeless antiresonant hollow core fibers”.

The arrangement of the cladding capillaries 204 in a ring around the inside of the tubular outer cladding 202 creates a central space, cavity, or void within the fiber, also with its longitudinal axis parallel to those of the outer cladding 202 and the cladding capillaries 204, which is the fiber's hollow core 206. The hollow core 206 is bounded by the inwardly facing parts of the outer surfaces of the cladding capillaries 204. This is the core boundary, and the material (glass or polymer, for example) of the capillary walls that make up this boundary provides the required antiresonance optical guidance effect or mechanism. The cladding capillaries 204 have a thickness, t, at the core boundary which defines the wavelength for which antiresonant optical guiding occurs in the ARF.

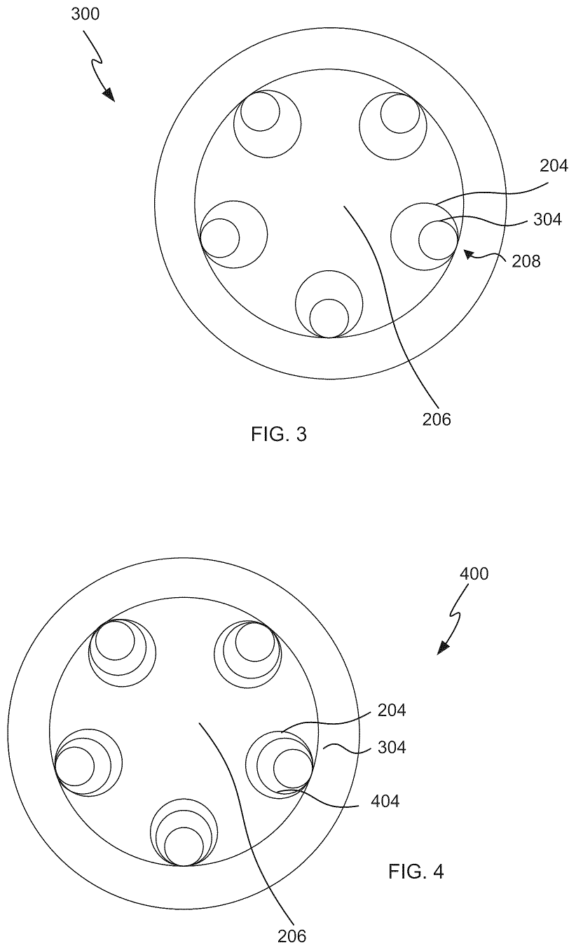

In the second example, shown in FIG. 3, each primary cladding capillary 204 has a secondary, smaller capillary 304 nested inside it, bonded to the inner surface of the primary cladding capillary 204, in this example at the same azimuthal location 208 as the point of bonding between the primary cladding capillary 204 and the outer cladding 202. These additional smaller capillaries 304 can reduce the optical loss. ARF designs of this type, with secondary capillaries, may be referred to as “nested antiresonant nodeless fibers” (NANFs).

The third example, shown in FIG. 4, has two smaller cladding capillaries 304, 404 nested inside each cladding capillary 204. As with the example shown in FIG. 3, each of the smaller capillaries 304, 404 is bonded to the inner surface of the immediately larger capillary at the same azimuthal location as the point of bonding between the primary cladding capillary 204 and the outer cladding 202. In this example, the smaller capillary 404 may be referred to as the secondary cladding capillary and the smallest cladding capillary 304 may be referred to as the tertiary cladding capillary. The tertiary cladding capillary 304 is bonded to the inner surface of the secondary cladding capillary 404 and the secondary cladding capillary 404 is bonded to the inner surface of the primary cladding capillary 204. ARF designs of this type, with secondary and tertiary cladding capillaries may be referred to as “double-nested antiresonant nodeless fibers” (DNANFs). In yet further examples (not shown in the drawings) there may a different configuration of cladding capillaries. For example, there may be smaller further capillaries, within the tertiary capillary 304 to provide further levels of nesting and/or there may be a plurality of secondary cladding capillaries within each primary cladding capillary, each secondary cladding capillary being bonded to the inner surface of the primary cladding capillary at a different azimuthal location and/or each primary cladding capillary may have an internal structure (e.g. one or more dividing walls) or the cladding capillaries may not be fully closed tubes.

All of the examples shown in FIGS. 2-4 comprise five primary cladding capillaries 104 and hence have five-fold rotational symmetry. Furthermore, all the capillaries are circular in cross-section. In other examples, there may be a different number of capillaries surrounding the core (e.g. four, six, seven, eight, nine or ten) and/or the capillaries may not be of circular cross-section. Additionally, whilst in the examples of FIGS. 2-4, all the primary cladding capillaries 204 are of the same size and shape, in other examples, the primary capillaries within the outer cladding 202 may not all be the same size and/or shape. Furthermore, whilst in the examples of FIGS. 2-4, the primary cladding capillaries do not touch the neighboring primary cladding capillaries (and hence the ARF are described as “nodeless”), in other examples, adjacent primary cladding capillaries may be in contact with each other.

Where HCF is used in an optical network, the HCF is usually used in combination with single mode fiber (SMF), such that a length of SMF is connected to a length of HCF. It is this combination of a length of SMF (or other form of SCF) coupled to a length of HCF that limits the use of OTDR in the conventional manner to look for faults or flaws in the HCF. HCFs have much lower backscattering levels than SMF. SMF shows a backscattering of approximately −70 to −60 dB/m of the incident light on its core due to Rayleigh scattering from density fluctuations in the glass. In contrast, the level of backscattering from glass surfaces in HCFs and DNANF and NANF in particular, is approximately −40 dB below SMF (e.g. approximately −110 dB/m). The dominant mechanism of backscattering in (D)NANF is Rayleigh backscattering from the gas molecules inside the hollow core. This is approximately proportional to density and is about 27-30 dB below SMF (e.g. about −100 dB/m for air at atmospheric pressure).

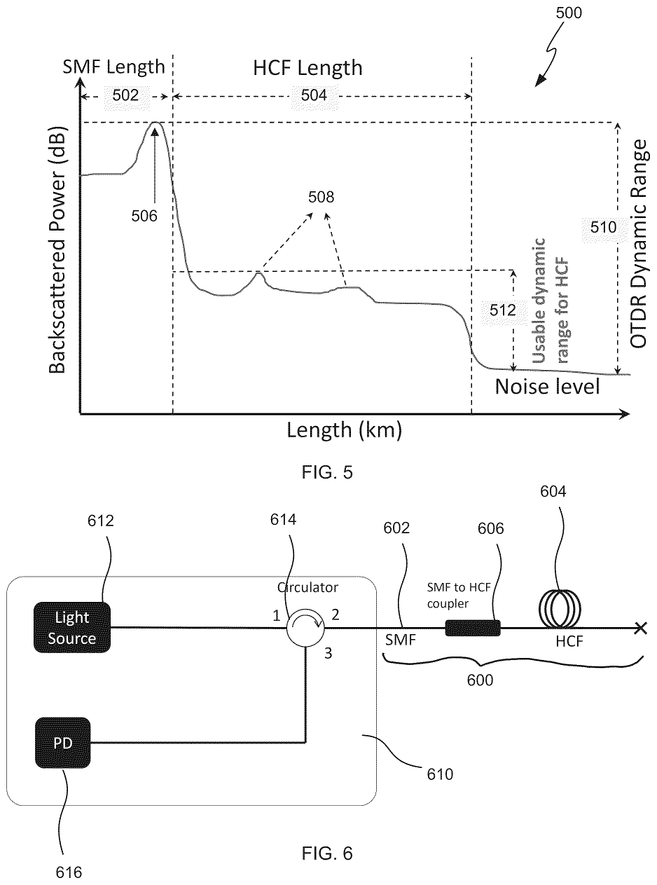

Even if a transition region is introduced between the SCF and the HCF to reduce losses (and reflections) at the transition (e.g. by expanding the mode of the SMF so that its output field is better matched to that of the HCF and cleaving the SCF and HCF at an angle) the large difference in the backscattering levels between SMF and HCF significantly reduces the usable dynamic range of the OTDR on the part of the OTDR trace graph that corresponds to the length of HCF, as shown in FIG. 5. This makes it much more difficult to identify faults or flaws in the HCF at relatively longer distances (e.g. over distances of a few kilometers or longer), particularly faults or flaws that introduce small amounts of backscattering (but which may still impair the operation of the optical network and so need to be identified and addressed).

FIG. 5 shows an example OTDR trace graph 500 for a FUT 600 that may be generated using OTDR apparatus 610, as shown in FIG. 6. The FUT 600 comprises a length of SMF 602 coupled to a length of HCF 604 via a SMF to HCF coupler 606. The OTDR apparatus 610 comprises a light source 612, circulator 614 and PD 616. It will be appreciated that the OTDR apparatus 610 may comprise other elements not shown in FIG. 6. The optical pulse emitted from the light source 612 is coupled into a first port of the circulator 614 and output to the FUT 600 that is connected to a second port of the circulator 614. The pulse is reflected back from the FUT (as described above) and the reflected light enters the circulator 614 at the second port and is output to the PD 616 that is connected to the third port of the circulator 614. The trace graph 500 is generated using the output signal from the PD 616.

The horizontal axis of the OTDR trace graph 500 shows the distance along the FUT and the vertical axis shows the (absolute or relative) backscattered power. The length of the SMF and HCF are shown on the trace graph (arrows 502, 504 respectively). The trace graph 500 shows a peak 506 caused by reflections at the SMF-HCF interface as well as events (e.g. peaks or troughs) 508 due to imperfections in the HCF. The overall dynamic range of the OTDR is shown (arrow 510) and it can be seen that this is much larger than the usable dynamic range of the OTDR apparatus for HCF (arrow 512), e.g. the overall dynamic range 510 is more than twice that of the usable dynamic range 512 for the HCF portion of the FUT.

Described herein are methods and apparatus for performing OTDR on HCF. In particular described herein is a hollow core fiber launch tail for use when performing OTDR or Optical Frequency Domain Reflectometry (OFDR) on a hollow core fiber (i.e. where the FUT is HCF). Also described herein are methods of manufacturing the hollow core fiber launch tail and methods of performing OTDR and OFDR on HCF using the HCF launch tail.

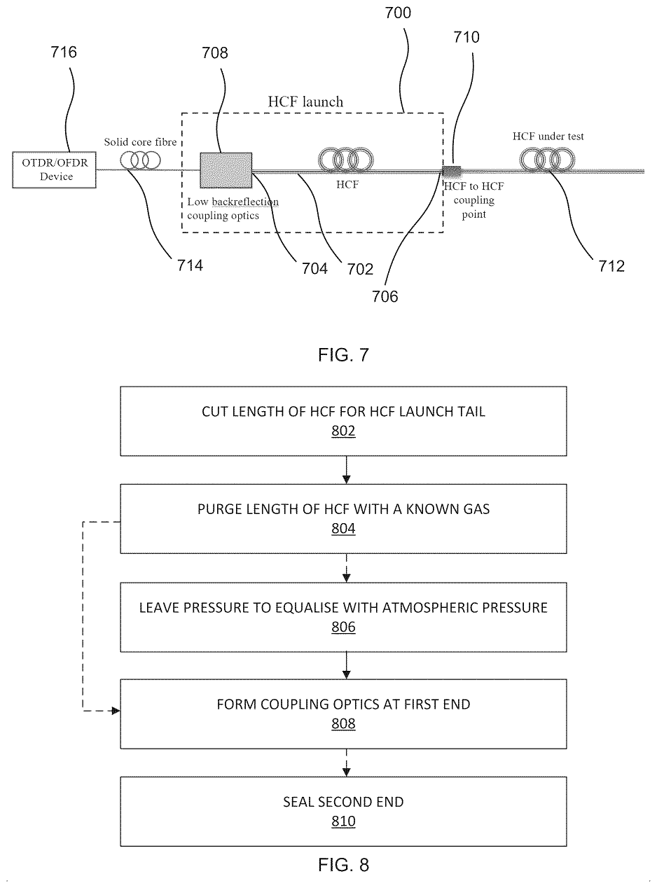

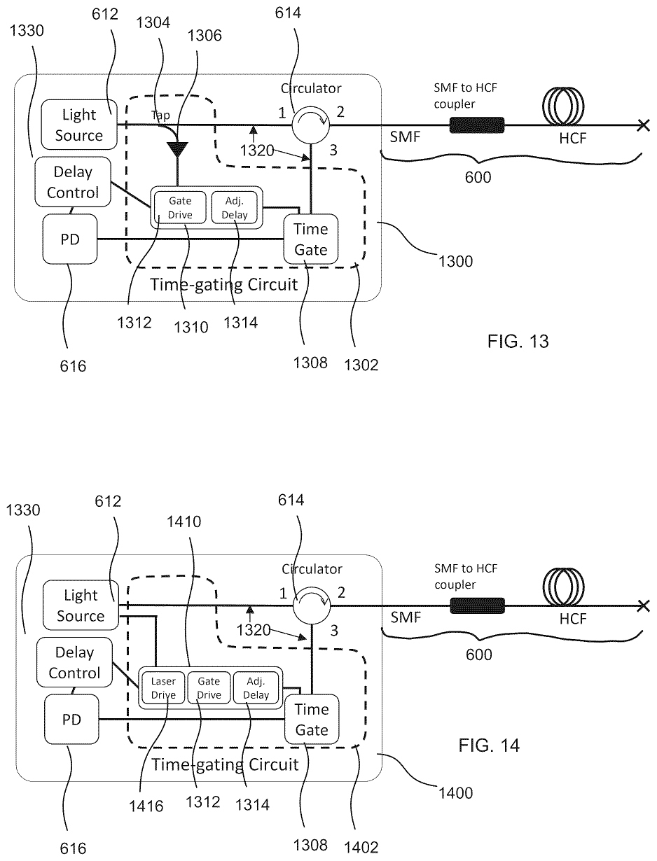

FIG. 7 is a schematic diagram showing an example test arrangement for OTDR or OFDR using a HCF launch tail 700. The HCF launch tail 700 comprises a length of HCF 702 having a first end 704 and a second end 706. The OTDR launch tail 700 further comprises coupling optics 708 coupled to the first end 704 of the length of HCF 702. In the example shown in FIG. 7, the coupling optics 708 are low back reflection coupling optics which are configured to couple light between the length of HCF 702 and a solid core fiber (e.g. to SMF) in a manner that minimizes back reflections of light travelling in the solid core fiber towards the hollow core fiber at the solid core fiber to hollow core fiber interface. Where the HCF launch tail 700 is used for OFDR, the coupling optics 708 are always low back reflection coupling optics; however where the HCF launch tail 700 is used for OTDR, the coupling optics 708 may have an arbitrary back reflection level. Where low back reflection coupling optics are not used, the OTDR device may be selected (or modified) to accommodate the level of back reflection. For example, time-gated OTDR may be used to avoid significant event dead zone (saturation) as a consequence of the coupling. Examples of OTDR apparatus with time-gating are described below with reference to FIGS. 13-15 and also in International Patent Application PCT/US2024/053412 which is incorporated herein in its entirety.

Whilst FIG. 7 shows a test arrangement for uni-directional testing (e.g. uni-directional OTDR testing), it will be appreciated that HCF launch tail described herein may also be used in bi-directional OTDR testing (e.g. where there is a HCF launch tail connected to each end of the FUT and a second OTDR device 716).

FIG. 8 shows an example method of manufacturing a HCF launch tail as described herein, which starts by cutting, or otherwise obtaining, a length of HCF of the desired length for the launch tail (block 802). The length of HCF may, for example, be between 30 m and 2000 m long. For OTDR applications, the length may be selected such that it is long enough to avoid event and attenuation dead zones created by the coupling optics 708 and so that it can be repeatedly cut and respliced at the second end 706 (to form the HCF to HCF coupling 710 to connect successive FUTs) but short enough to avoid significant power loss. The minimum length selected may also depend upon the pulse width of the signal output by the OTDR device 716. For OFDR applications, the length of the HCF in the launch tail is at least a few hundred meters (e.g. more than 200 m in length) and the length selected may depend on the phase noise characteristics of the laser in the OFDR device 716.

The hollow core of the length of HCF 702 (e.g. hollow cores 104, 206 in the example HCFs shown in FIGS. 1-4) is filled within a known gas (block 804). The hollow core of the length of HCF 702 may be filled with the known gas at a pressure that is equal to, or exceeds, atmospheric pressure (in block 804). In other examples, the pressure of the known gas may be below atmospheric pressure; however, this increases the risk of contamination compared to using pressures above atmospheric pressure (as described in more detail below). In some examples, all the voids in the HCF (e.g. the voids within the tubular cladding capillaries 204, 304, 404 shown in FIGS. 2-4) are filled with the same known gas to a similar pressure. The length of HCF 702 may be filled with the known gas by purging the HCF with the known gas to a pressure above atmospheric pressure and then allowing the pressure within the HCF to fall back towards atmospheric pressure prior to use (block 806) e.g. by leaving the HCF with the second end 706 open for a period of time. The second end 706 may subsequently be sealed for storage (block 810) and then unsealed prior to coupling to the FUT. Alternatively, the sealing may be implemented by connectorizing the HCF at the second end 706 (in block 810), i.e. by forming or connecting an HCF connector at the second end 706. The known gas may be Argon or Nitrogen. In other examples different gases may be used (e.g. dry air, Helium, etc.) and for some uses of the HCF launch tail 700, gases such as Carbon Dioxide, Acetylene (C₂H₂), or other CₙHₘ gases (where n and m are integers and may have the same or different values) may be used, either in pure form or in a known concentration mixed with another gas.

Purging the length of HCF 702 (in block 804), as described above, provides a known atmosphere within the hollow core and prevents the degradation of the transmission and scattering characteristics of the length of HCF 702 over time (e.g. as a consequence of contaminants in an uncontrolled atmosphere which may precipitate out over time onto surfaces that surround the hollow core). In examples where the pressure within the length of HCF 702 is never below that of atmospheric pressure, as a consequence of the purging with the known gas to a pressure that equal to or above atmospheric pressure, it also prevents ingress of contaminants, e.g. when the second end 706 is left open to the atmosphere (i.e. when the second end 706 is not sealed). Where pressures below atmospheric pressure are used when purging with the known gas, sealing of the second end (in block 810) may be used to reduce the risk of contamination within the HCF launch tail 700.

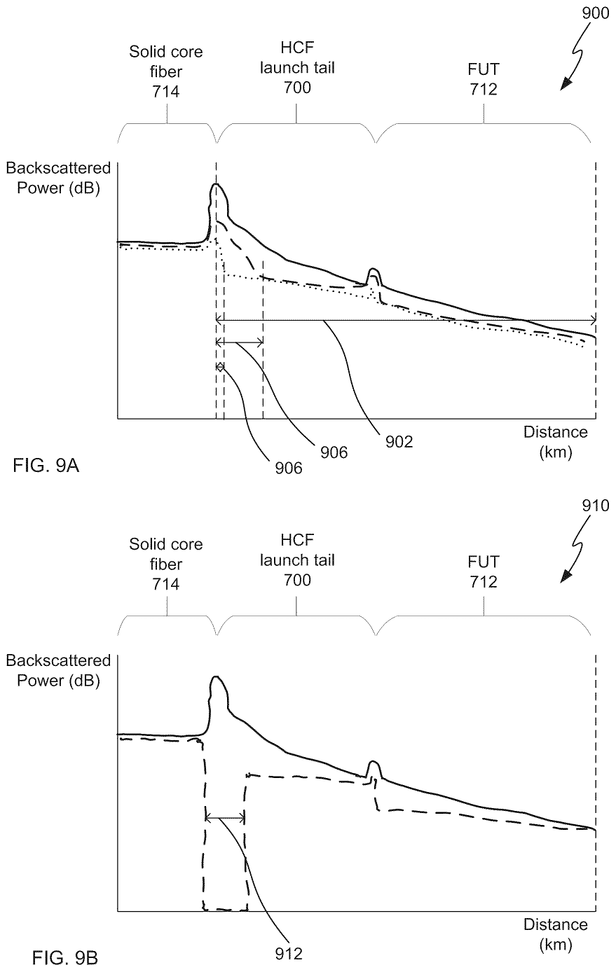

The coupling optics 708 is formed on one end of the length of HCF (i.e. on the first end 704) after purging (block 808). Where the coupling optics 708 are low back reflection coupling optics, they may comprise both an angled interface and an anti-reflective coating, e.g. as described in “Low loss and broadband low back-reflection interconnection between a hollow-core and standard single-mode fiber,” Dmytro Suslov et. al, Opt. Express 30, 37006-37014 (2022). In other examples the low back reflection coupling optics may comprise an arrangement of lenses that matches the modal field of the OTDR/OFDR light to the optical mode of the HCF in the launch tail.

Where the coupling optics 708 in the HCF launch tail 700 are low back reflection coupling optics, any suitable low back reflection coupling optics may be used. Low back reflection coupling optics may be considered suitable for use in the HCF launch tail 700 if they provide a level of back reflection that is low enough that any dead zone caused by overload (i.e. saturation) of the photodetector in the OTDR apparatus 716 does not extend over a significant proportion of the part of the OTDR trace corresponding to the length of HCF 702 in the HCF launch tail 700. Suitable low back reflection coupling optics may have a level of back reflection that is below 50 dB or below −55 dB (with high back reflection levels being defined as more than 20 dB or −40 dB depending on the application). The effect of different levels of back reflection are described below in relation to OTDR with reference to FIGS. 9A and 9B. For use with an OFDR device, the back reflection of the coupling optics 708 needs to be low enough that its signature which contains phase and noise characteristics of the laser (that is in the OFDR device) does not overwhelm the backscatter signal from a substantial length of the HCF 702 in the launch tail.

FIG. 9A shows an example OTDR graph 900 for three different HCF launch tails, one shown by the solid line, one by the dashed line and one by the dotted line and assumes that time-gating (or other mitigation measures) is not implemented within the OTDR apparatus. The graph plots backscattered power (on the y-axis) against distance (on the x-axis) and the regions corresponding to each of the solid core fiber 714, the HCF launch tail 700 and the FUT 712 are indicated. In this example, the only difference between the HCF launch tails is the level of back reflection that is achieved by the coupling optics 708 at the first end 704 of the length of HCF 702 in the HCF launch tail 700. The level of back reflection provided by the coupling optics in the first HCF launch tail shown by the solid line is highest (e.g. up to −15 dB) and the level of back reflection provided by the coupling optics in the third HCF launch tail shown by the dotted line is lowest (e.g. below −55 dB). The level of back reflection provided by the coupling optics in the second HCF launch tail shown by the dashed line is between that of the other two HCF launch tails. FIG. 9A also includes arrows 902-906 which indicate the relative length of the dead zones in the plots that result from the back reflections at the coupling optics 708 overloading the photodetector in the OTDR/OFDR device 716.

For the first HCF launch tail (shown by the solid line), the dead zone extends over at least the entire length of the OTDR trace that corresponds to the HCF launch tail and may extend over some or all of the length of the OTDR trace that corresponds to the FUT, arrow 902. Consequently the coupling optics used in the first HCF launch tail are not suitable. For the second HCF launch tail (shown by the dashed line), the dead zone extends over around a third of the entire length of the OTDR trace that corresponds to the HCF launch tail, arrow 904. Consequently the coupling optics used in the second HCF launch tail may also not be considered suitable (although this may be application dependent). For the third HCF launch tail (shown by the dotted line), the dead zone extends over only a very small proportion of the length of the OTDR trace that corresponds to the HCF launch tail, arrow 906. Consequently the coupling optics used in the third HCF launch tail are suitable.

FIG. 9B shows an example OTDR graph 910 for the first and second HCF launch tails shown in FIG. 9A and demonstrates the effect of using time-gating within the OTDR device 716. The solid line in the graph of FIG. 9B is the same as that shown in FIG. 9A (i.e. first HCF launch tail, no time-gating), whereas the dotted line shows the second HCF launch tail and the use of time-gating in the OTDR device 716. A dead zone 912 caused by the time-gating is clearly visible in the OTDR trace.

As shown in FIG. 7, in use the second end 706 of the length of HCF 702 is coupled, at a HCF to HCF coupling point 710, to the FUT 712 which is HCF. This HCF to HCF coupling point 710 may, for example, be a fusion splice or a mechanical splice. Where a fusion splice is used, the length of HCF 702 may be cut back and re-cleaved for each new FUT 712. This reduces the length of the length of HCF 702 by only a few centimeters each time and the purging with known gas (as described above) which results in the pressure inside the HCF being no lower than atmospheric pressure inhibits ingress of debris when cutting back and cleaving. This improves the quality of the connection between the two lengths of HCF (at the coupling point 710) and reduces the optical loss and back reflection level. In other examples, where a HCF connector is attached to the second end 706 of the length of HCF, the coupling to the FUT (at coupling point 710) may be HCF connector to HCF connector (e.g. where the FUT is also connectorized).

Furthermore, in use, the coupling optics 708 couple the first end 704 of the length of HCF 702 to the OTDR/OFDR device 716. This coupling may be via a length of solid core fiber 714 which is coupled to, or may be part of, OTDR/OFDR test apparatus 716 or alternatively, the OTDR/OFDR device 716 may be designed to couple light into the coupling optics 708 directly through free space (e.g. the solid core fiber 714 shown in FIG. 7 may be omitted).

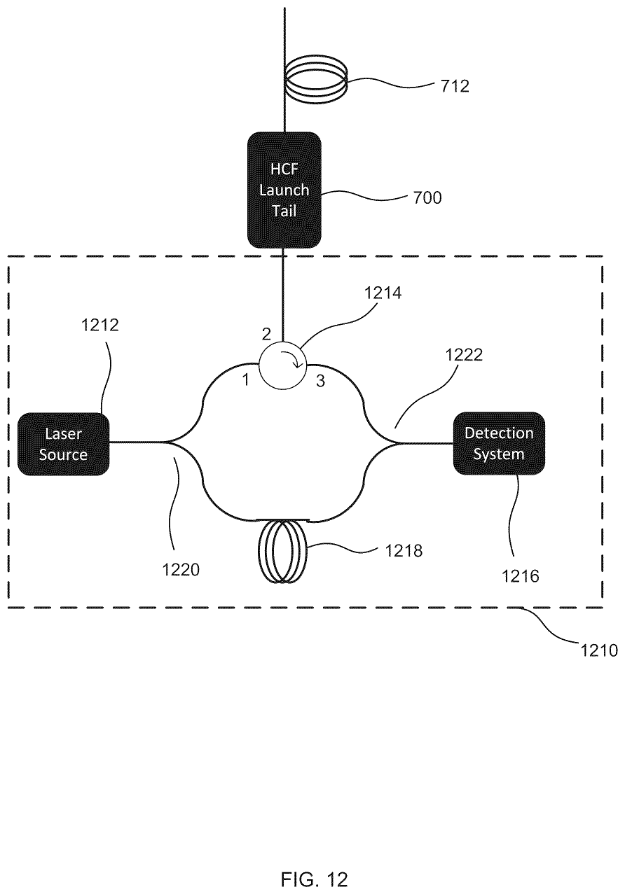

The OTDR/OFDR device 716 may be the same as the OTDR apparatus 610 shown in FIG. 6 and described above, with the solid core fiber 714 corresponding to SMF 602 shown in FIG. 6, although in the example shown in FIG. 7, the solid core fiber 714 is not considered to be part of the FUT (unlike in FIG. 6). In other examples, the OTDR/OFDR device 716 may be the same as the OFDR apparatus 1210 shown in FIG. 12 and described below or the same as the OTDR apparatus shown in FIGS. 13-14 and described below.

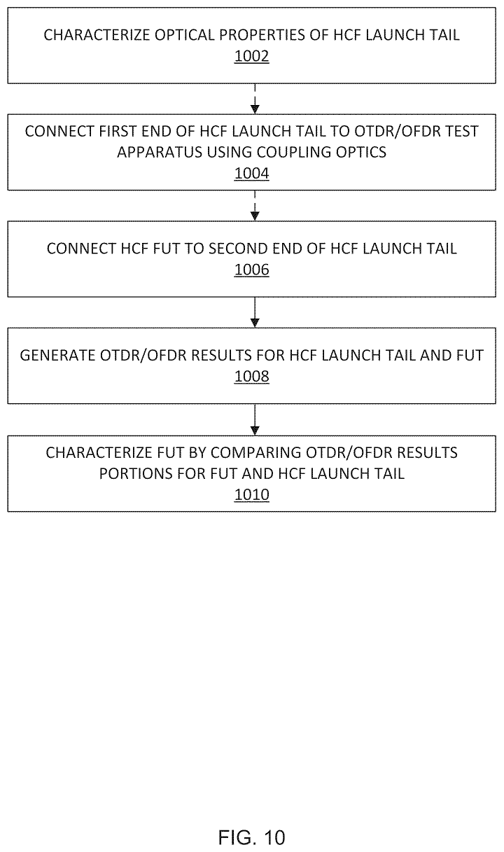

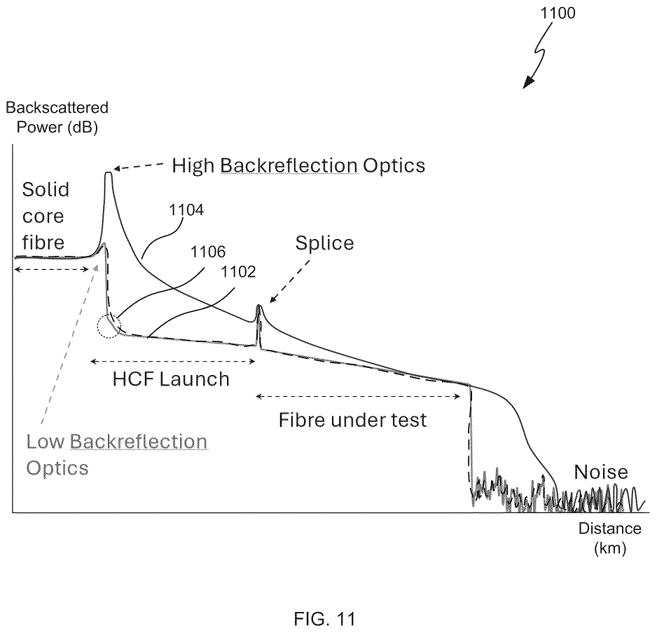

As shown in FIGS. 9A and 9B, the use of a HCF launch tail 700 shifts the portion of the OTDR trace which relates to the FUT 712 to the right (i.e. to a longer distance position on the graph, as it is now further from the OTDR/OFDR device 716) and so moves it further from the dead zone that results from any back reflections from the interface between the solid core fiber 714 and HCF. This improves the accuracy of the OTDR results for the FUT 712. In addition, the use of a HCF launch tail 700 enables additional and/or more accurate characterization of the FUT 712, e.g. polarization dependent parameters, group delay, loss, backscattering coefficient, etc. This can be described with reference to FIGS. 10 and 11.

FIG. 10 is a graph of an example method of characterizing a HCF FUT using a HCF launch tail as described herein and FIG. 11 shows an example OTDR graph 1100 for two different HCF launch tails, one shown by the dotted line 1102 where the HCF launch tail includes low back reflection coupling optics as described above, and the other, by way of comparison, shown by the solid line 1104 where the HCF launch tail includes high back reflection optics and time-gating (or other mitigation steps for the dead zone) are not used. In a similar manner to that shown in FIG. 9A and described above, where the HCF launch tail includes high back reflection optics and time-gating is not used, there is a long dead zone which in the example shown in FIG. 11 extends the entire length of both the HCF launch tail and the FUT and means that it is not possible to use the results to characterize the FUT. If, however, time-gating is used in combination with high back reflection coupling optics, the effect of the dead zone is mitigated (as shown in FIG. 9B) and it is possible to use the results to characterize the FUT.

The method of characterizing a HCF FUT shown in FIG. 10 comprises characterizing the properties of the HCF launch tail (block 1002) and then connecting the first end of the HCF launch tail to the OTDR/OFDR test apparatus using coupling optics (block 1004). Either or both of these steps may be performed in advance of the testing of the FUT, as indicated by the dotted arrows in FIG. 10. The characterization of the HCF launch tail (in block 1002) may be performed using equipment other than the OTDR/OFDR test apparatus, e.g. using power meters and polarization resolved reflectometry equipment, and may be performed using more than one test arrangement. This characterization operation (in block 1002) may characterize the entire HCF launch tail (including the coupling optics) or just the length of HCF and may measure parameters such as optical loss, distributed reflections and localized scattering events, i.e. it characterizes the longitudinal uniformity and integrity of the fiber. The characterization operation (in block 1002) need only be performed once for each HCF launch tail since the purging with a known gas minimizes any degradation over time of the performance of the HCF launch tail.

In order to test a HCF (the FUT), the method comprises connecting the HCF FUT to the second end of the HCF launch tail (block 1006), generating OTDR/OFDR results (e.g. an OTDR trace graph) for the combination of the HCF launch tail and the FUT (block 1008) and then analyzing the results (e.g. the OTDR trace graph) to characterize the FUT by comparing the portion of the results (e.g. the portion of the OTDR trace graph) corresponding to the FUT to the portion of the results (e.g. the portion of the OTDR trace graph) corresponding to the HCF launch tail (block 1010). These last three steps (blocks 1006-1010) may be repeated for each new HCF that is to be tested and, as described above, the FUT may be connected to the HCF launch tail using any HCF to HCF coupling technology, such as fusion or mechanical splicing.

The connection that is formed (in block 1006) between the FUT and the HCF launch tail may be a splice, e.g. a fusion splice or a mechanical splice, or any other coupling mechanism such as a connector or butt-coupling. The results that are obtained are improved by forming a low loss, low back reflection connection between the HCF launch tail and the FUT because any dead zone will be small and there will be a high dynamic range. Aligning the microstructure within the FUT and the HCF launch tail when forming the connection results in a low loss, low back reflection connection because it is a connection between two lengths of HCF, instead of a connection between solid core and hollow core fiber.

The comparison of the portions of the OTDR trace graph (in block 1010) may comprise comparing the slope (i.e. gradient) of the portion of the OTDR trace graph corresponding to the FUT to the portion of the OTDR trace graph corresponding to the HCF launch tail. For example, where bi-directional OTDR is used, the comparison may be used to determine the relative loss coefficient of the HCF tail and the FUT. The portions of the OTDR trace that are used in the comparison may exclude any portions of the OTDR trace that is affected by a dead zone or by other artifacts (such as the region 1106 at the start of the part of the OTDR trace corresponding to the HCF launch fiber in which the backscattered power drops rapidly, compared to the rest of the part of the OTDR trace corresponding to the HCF launch fiber, and which is due to ingress of air into the HCF launch fiber at the low back reflection optics). As the optical properties of the HCF launch tail have been fully characterized (in block 1002), the comparison of the FUT to the HCF launch tail (in block 1010) may provide more accurate measurements of optical loss, polarization dependent parameters, group delay and backscattering coefficients compared to analyzing the OFDR trace for the FUT in isolation.

Whilst the method of FIG. 10 describes characterizing the FUT in terms of detecting optical properties of the FUT, the method and/or the HCF launch tail described herein may also be used to detect breaks in the FUT. By using a HCF launch tail as described herein it is possible to detect breaks that are very close to the beginning of a link and would otherwise be undetectable because the reflections from the break fall within a dead zone.

Whilst FIGS. 10 and 11 relate to the use of the test arrangement in FIG. 7 for OTDR (e.g. where the OTDR/OFDR test apparatus 716 may be the same as the OTDR apparatus 610 shown in FIG. 6 and described above), this arrangement may also be used for OFDR where the OTDR/OFDR test apparatus 716 is OFDR apparatus, such as the example OFDR apparatus 1210 shown in FIG. 12.

The OFDR apparatus 1210 comprises a laser source 1212, circulator 1214, a detection system 1216, a reference length of fiber 1218, a splitter 1220 and a coupler 1222. It will be appreciated that the OFDR apparatus 1210 may comprise other elements not shown in FIG. 12. The laser source 1212 is a narrow line width tunable laser source and in use, the wavelength of the output may be swept rapidly over a wavelength range that is much broader than its line width. The optical pulse emitted from the laser source 1212 is split between two paths using the splitter 1222. Light from the first path is coupled into a first port of the circulator 1214 and output to the FUT 712 via the HCF launch tail 700 (as described above) that is connected to a second port of the circulator 1214. The incident light is reflected back from the FUT (as described above) and the reflected light enters the circulator 1214 at the second port and exits at the third port. Light from the second path of the splitter 1220 travels along a reference length of fiber 1218. The coupler 1222 combines the light received at the third port of the circulator 1214 and the light from the reference length of fiber 1218, causing interference between the two beams, and the light is output to the detection system 1216. The detection system 1216 comprises various components such as polarization splitters and balanced photodetectors.

In other examples, the reference fiber 1218 and splitter 1220 may be omitted and a local oscillator (e.g. an exact copy of the laser) used instead. In such an example, light from the laser source 1212 is coupled directly into the first port of the circulator 1214 and light from a local oscillator is combined with the light received at the third port of the circulator 1214 and then input to the detection system 1216.

For hollow core fibers, OFDR only detects backscatter from fixed scatterers within the fiber, i.e. scatterers on the surfaces within the hollow core fiber microstructure, such as from surface roughness, defects, debris or particulates (e.g. which may have precipitated out of the gas in the FUT). As with OTDR, strong reflections anywhere along the measurement paths can cause the photodetectors in the detection system to saturate, limiting its dynamic range and making it unable to measure low-level reflections or backscatter from other parts of the FUT. In addition, for OFDR, strong reflections can cause distortions in the coherent interference pattern (generated as a consequence of combining the reflected light from the FUT with light from the reference fiber 1218 or local oscillator) making it difficult to interpret the signal, e.g. it can add a DC bias to the trace generated by the detection system (e.g. the equivalent to the OTDR traces shown in FIGS. 5 and 9), which makes it harder to distinguish smaller features from the trace and hence harder to detect the presence of smaller scatterers within the FUT. Strong reflections may, in addition or instead, create ghost reflections which can be misidentified as defects in the FUT.

By using the HCF launch tail 700 as described herein, any reflections from the joins between the OFDR apparatus 1210 and the FUT 712 are minimized, thereby improving the ability to detect small scatterers. Additionally, use of the HCF launch tail 700 reduces the time taken to perform the OFDR test because performing a HCF-HCF splice (to connect the FUT 712 to the HCF launch tail 700) is much quicker than preparing a low back reflection coupling between solid-core fiber and HCF which would otherwise be required before testing a new FUT.

The method of FIG. 10 may also be used for OFDR and in such an example there may be additional or alternative parameters which are measured when performing the characterization of the HCF launch tail (in block 1002). For example, where a HCF launch tail is characterized for use in an OFDR test arrangement, the characterization may include measurement of the distributed birefringence and group delay of the HCF launch tail. By using the method of FIG. 10 with OFDR, the levels of backscatter in the various portions of the OFDR results can be compared to detect changes in the core size of the fibers.

FIGS. 13 and 14 show two different examples of OTDR apparatus 1300, 1400 that are adapted for use with HCF by using time-gating. Both examples of OTDR apparatus 1300, 1400 comprise a light source 612, circulator 614, PD 616 and time-gating circuit 1302, 1402. It will be appreciated that the OTDR apparatus 1300, 1400 may comprise other elements not shown in FIGS. 13 and 14. The time-gating circuit 1302, 1402 is configured to block all or a significant proportion of the backscattered light from the SMF section of the FUT from reaching the PD 616. The blocking of the light may be achieved by absorbing, diverting or significantly attenuating (e.g. attenuating by 50-60 dB or more) the backscattered light from the SMF section. The PD 616 is coupled to an output of the time-gating circuit 1302, 1402 and may be a non-photon-counting PD.

The time-gating circuit 1302 shown in the OTDR apparatus 1300 in FIG. 13 comprises an optical tap coupler 1304, a second PD 1306, an optical switch 1308 and switch control circuitry 1310 that includes drive circuitry 1312 for the optical switch 1308 and an adjustable delay and pulse width element 1314. The combination of the tap coupler 1304 and second PD 1306 are used to detect when a pulse is emitted by the light source 612 and sent into the FUT 600. The tap coupler 1304 may, for example, tap 10% of the optical power emitted by the light source 612. Alternatively, a different proportion of the light may be tapped by the tap coupler 1304 (e.g. 1% or 5% or 15%). The second PD 1306 detects the pulse in the tapped light and this is provided as an input to the switch control circuitry 1310. The light source and PD can be integral parts of a commercial OTDR device.

The switch control circuitry 1310 outputs a control signal to the optical switch 1308 to trigger the switch 1308 to open at a time after the pulse is detected by the PD 1306 and the time delay between the detection of the pulse by the PD 1306 and the opening of the switch 1308 is set by the adjustable delay element 1314. When the switch 1308 is closed (e.g. before it receives the trigger control signal from the switch control circuitry 1310), light that is received via the third port of the circulator 614 is blocked by the switch (i.e. attenuated, absorbed or deflected by the switch 1308) such that at least a significant proportion of the light that is received via the third port of the circulator 614 is not incident upon (i.e. does not reach) the PD 616 and hence is not included in any OTDR trace graph that is generated. Once the switch 1308 is opened (as a consequence of receiving the trigger control signal from the switch control circuitry 1310), light that is received via the third port of the circulator 614 is not blocked (and so does reach the PD 616) and hence is used to generate an OTDR trace graph. The adjustable delay element 1314 is set to provide a signal such as a pulse with a certain width and delay which has the effect that the backscattered light from the SMF is blocked (i.e. either attenuated, absorbed or deflected) by the switch 1308. The adjustable delay element 1314 therefore prevents the switch 1308 from opening until the light that reaches the switch 1308 comprises backscattered light from the HCF. The combination of the switch control circuitry 1310 and the switch 1308 selectively allows portions of the backscattered light within the FUT 600 to reach the PD 616. As described above, it blocks light backscattered within the SMF from reaching the PD 616 and allows light backscattered within the HCF to reach the PD 616.

The time-gating circuit 1402 shown in the OTDR apparatus 1400 in FIG. 14 comprises an optical switch 1308 and switch control circuitry 1410 that includes drive circuitry 1312 for the optical switch 1308, drive circuitry 1416 for the light source 612 and an adjustable delay element 1314. The switch control circuitry 1410 outputs a first control signal to light source to trigger the light source 612 to output a pulse (e.g. using the drive circuitry 1416 for the light source) and outputs a second control signal to the optical switch 1308 to trigger the switch 1308 (e.g. using the drive circuitry 1312 for the optical switch). The delay between the first control signal being output and the second control signal being output is set by the adjustable delay element 1314. As described above, when the switch 1308 is closed (e.g. before it receives the second control signal from the switch control circuitry 1310), light that is received via the third port of the circulator 614 is blocked (i.e. attenuated, absorbed or deflected) by the switch 1308 such that it does not reach the PD 616 and hence is not included in any OTDR trace graph that is generated. Once the switch 1308 is opened (as a consequence of receiving the second control signal from the switch control circuitry 1310), light that is received via the third port of the circulator 614 does reach the PD 616 (e.g. without any significant attenuation by the switch 1308) and hence is used to generate an OTDR trace graph. As in the arrangement of FIG. 13, in the arrangement of FIG. 14, the adjustable delay element 1314 is set to provide a delay which has the effect that any backscattered light from the SMF does not reach the PD 616 (i.e. is not incident upon and detected by the PD 616) but is instead blocked (i.e. attenuated, absorbed or deflected) by the switch 1308. The adjustable delay element 1314 therefore prevents the switch 1308 from opening until the light that reaches the switch 1308 comprises backscattered light from the HCF.

The optical switch 1308 that is used in the OTDR apparatus 1300, 1400 shown in FIGS. 13 and 14 may have an extinction ratio that is at least twice a target dynamic range 1010 (as shown in FIG. 10) of the OTDR apparatus (e.g. to ensure that backscattered light from the SMF is absorbed, significantly attenuated or deflected when the switch is closed). In an example, this target dynamic range may be greater than or equal to 30 dB. The optical switch 1308 may also have a switching time that is comparable to, or faster than, the rise and fall time of the pulse emitted by the light source 612 (e.g. a rise and fall time of the order of a few nanoseconds). By having a switch with a fast switching time, it enables more of the backscattered light from the HCF to be captured by the PD. The optical switch 1308 may take any form that can perform the blocking described above (e.g. by absorbing, attenuating or deflecting a significant proportion of the input light when in the switch is closed and allowing the light to pass through when the switch is open) and may, for example, be an acousto-optic modulator, variable attenuator, electro-optic modulator, intensity or phase modulator, Mach-Zehnder interferometer, semiconductor optical amplifier, modulated fiber amplifier, microelectromechanical switch, etc.

Although not shown in FIGS. 13 and 14, the OTDR apparatus 1300, 1400 may additionally comprise one or two optical amplifiers: one positioned between the light source 612 and the circulator 614 and the other positioned between the circulator 614 and the optical switch 1308 (with these positions indicated by arrows 1320 in FIGS. 13 and 14). These two optical amplifiers increase both the power of the pulse that is injected into the FUT and the power of the backscattered light from the FUT. This improves the signal-to-noise ratio (SNR) and hence the dynamic range of the OTDR apparatus which can reduce the overall test time as well as enabling testing of longer FUT.

Although not shown in FIGS. 13 and 14, the OTDR apparatus 1300, 1400 may comprise an additional SMF length before the circulator 614 to create a fixed signal delay to make sure that the detection and time-gating circuitry operate before the SMF backscattering reaches the PD. Such additional SMF length can be located between the tap coupler 1304, and port 1 of the circulator, 1320.

In a variation of the arrangements shown in FIGS. 13 and 14, the circulator 614 may be replaced an alternative optical device which achieves the same optical functions - i.e. light emitted by the light source is coupled into the FUT and light reflected within the FUT is coupled into an input port of the optical switch. For example, the circulator 614 may be replaced with a four-port coupler.

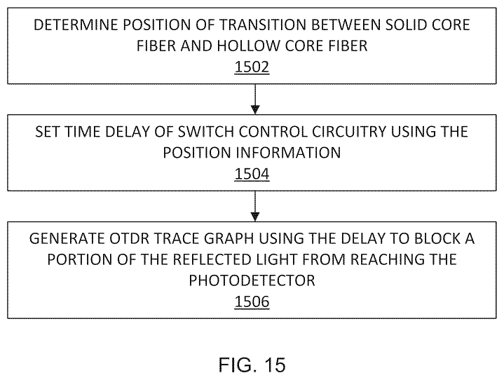

FIG. 15 shows a first example method of performing OTDR on a FUT that comprises a portion of HCF and a portion of SCF, such as SMF (e.g. FUT 600). The method may be implemented using the OTDR apparatus 1300, 1400 shown in FIG. 13 or 14 and described above. The method comprises determining a position of a transition within the FUT between the SCF and the HCF (block 1502). Using the determined position (from block 1502), the time delay of an adjustable delay element 1314 is set (block 1504) and then an OTDR trace graph is generated using this delay circuit to control an optical switch 1308 and selectively block (e.g. absorb, significantly attenuate or divert) a portion of the reflected light from reaching a PD 616 (block 1506). Where the FUT comprises a length of SMF closest to the OTDR apparatus and a length of HCF coupled to the SMF, the portion of reflected light that is blocked (e.g. absorbed, significantly attenuated or diverted) is the initial portion of a pulse of light that is reflected by the length of SMF within the FUT. As a consequence of the blocking of the reflected light (i.e. at least a significant proportion of the reflected light) by the optical switch, the OTDR trace graph is generated (in block 1506) from light that is reflected within the HCF. This has the effect that the whole dynamic range of the OTDR apparatus 1300, 1400 is available to measure the HCF. Where the switch allows a small proportion of the light to pass through when in the closed state, this does not significantly impact the dynamic range that is available to measure the HCF.

The method of FIG. 15, and apparatus shown in FIGS. 13 and 14, may be used not only to block (e.g. absorb, attenuate or divert) the backscattered light from the SMF so that it is not used to generate the OTDR trace graph but also to block light from reflections caused by any other component in the FUT (or optical train including the FUT) before the HCF, such as switches, connectors, amplifiers and other optical devices.

Whilst the method of FIG. 15 describes generation of an OTDR trace graph, it will be appreciated that the method may not output the OTDR trace graph but may output data derived from the OTDR trace graph. The OTDR trace graph is a measure of the backscattered power and the method may further comprise processing this data and outputting data identifying events in the link (e.g. peaks or troughs). These events may be identified by analyzing the OTDR trace graphs to identify changes in the backscattered power. The event data that is output may identify the position of the identified events in the FUT and/or the nature of the identified events (e.g. where the nature of the event may be determined based on the nature of the change in the OTDR trace graph, e.g. whether it is a peak or a trough and/or based on the magnitude of the change in backscattered power).

Alternatively or in addition to the other examples described herein, examples include any combination of the following:
Clause A. A hollow core fiber launch tail for use in Optical Time Domain Reflectometry, OTDR, or Optical Frequency Domain Reflectometry, OFDR, measurements on hollow core fiber, the launch tail comprising: a length of hollow core fiber, having a first end and a second end; and coupling optics coupled to the first end of the length of hollow core fiber, wherein voids in the length of hollow core fiber are filled with a known gas.
Clause B: The hollow core fiber launch tail according to clause A, wherein the known gas is nitrogen.
Clause C: The hollow core fiber launch tail according to clause A, wherein the known gas is argon.
Clause D: The hollow core fiber launch tail according to any of the preceding clauses, wherein the voids in the length of hollow core fiber are filled with the known gas at a pressure that equals or exceeds atmospheric pressure
Clause E: The hollow core fiber launch tail according to any of the preceding clauses, wherein the coupling optics comprise low back reflection coupling optics.
Clause F: The hollow core fiber launch tail according to clause E, wherein the low back reflection coupling optics comprises an angled interface and an anti-reflective coating.
Clause G: Measurement apparatus comprising an OTDR/OFDR device and a hollow core fiber launch tail according to any of the preceding clauses, wherein the OTDR/OFDR device is coupled to the hollow core fiber launch tail via the coupling optics.
Clause H: Measurement apparatus according to clause G, further comprising a fiber under test, wherein the fiber under test comprises a second length of hollow core fiber and is coupled to the second end of the length of hollow core fiber in the hollow core fiber launch tail.
Clause I: A method of characterizing a hollow core fiber using a hollow core fiber launch tail according to any of clauses A-F, the method comprising: connecting the hollow core fiber to the second end of the length of hollow core fiber in the hollow core fiber launch tail, wherein an OTDR/OFDR device is coupled to the hollow core fiber launch tail via the low back reflection coupling optics in the hollow core fiber launch tail; generating OTDR/OFDR results for the hollow core fiber launch tail and the hollow core fiber (1008); and characterizing the hollow core fiber by comparing a first portion of the OTDR/OFDR results to a second portion of the OTDR/OFDR results, wherein the first portion of the OTDR/OFDR results corresponds to back reflections from the hollow core fiber and the second portion of the OTDR/OFDR results corresponds to back reflections from the hollow core fiber launch tail.
Clause J: The method according to clause I, wherein the OTDR/OFDR device comprises an OTDR device and the OTDR/OFDR results comprise an OTDR trace.
Clause K: The method according to clause J, wherein comparing a first portion of the OTDR trace to a second portion of the OTDR trace comprises: comparing a slope of the first portion of the OTDR trace to a slope of the second portion of the OTDR trace.
Clause L: The method according to any of clauses I-K, wherein connecting the hollow core fiber to the second end of the length of hollow core fiber in the hollow core fiber launch tail comprises: splicing the hollow core fiber to the second end of the length of hollow core fiber in the hollow core fiber launch tail.
Clause M: A method of manufacturing a hollow core fiber launch tail, the method comprising: cutting a length of hollow core fiber; purging the length of hollow core fiber with a known gas; allowing pressure of the known gas in the hollow fiber to equalize with atmospheric pressure; and forming coupling optics at a first end of the length of hollow core fiber.
Clause N: The method according to clause M, wherein the known gas is nitrogen.
Clause O: The method according to clause M, wherein the known gas is argon.
Clause P: The method according to any of clauses M-O, wherein purging the length of hollow core fiber with the known gas comprises purging the length of hollow core fiber with a known gas to a pressure above atmospheric pressure.
Clause Q: The method according to any of clauses M-P, wherein the coupling optics comprise low back reflection coupling optics.
Clause R: The method according to clause Q, wherein the low back reflection coupling optics comprises an angled interface and an anti-reflective coating.

Any range or device value given herein may be extended or altered without losing the effect sought, as will be apparent to the skilled person.

Embodiments of the disclosure comprise or utilize a special-purpose or general-purpose computer system that includes computer hardware, such as, for example, a processor system and system memory, as discussed in greater detail below. Embodiments within the scope of the present disclosure also include physical and other computer-readable media for carrying or storing computer-executable instructions and/or data structures. Such computer-readable media can be any available media accessible by a general-purpose or special-purpose computer system. Computer-readable media that store computer-executable instructions and/or data structures are computer storage media. Computer-readable media that carry computer-executable instructions and/or data structures are transmission media. Thus, embodiments of the disclosure can comprise at least two distinctly different kinds of computer-readable media: computer storage media and transmission media.

Computer storage media are physical storage media that store computer-executable instructions and/or data structures. Physical storage media include computer hardware, such as random access memory (RAM), read-only memory (ROM), electrically erasable programmable ROM (EEPROM), solid state drives (SSDs), flash memory, phase-change memory (PCM), optical disk storage, magnetic disk storage or other magnetic storage devices, or any other hardware storage device(s) which store program code in the form of computer-executable instructions or data structures, which can be accessed and executed by a general-purpose or special-purpose computer system to implement the disclosed functionality.

Transmission media include a network and/or data links that carry program code in the form of computer-executable instructions or data structures that are accessible by a general-purpose or special-purpose computer system. A “network” is defined as a data link that enables the transport of electronic data between computer systems and other electronic devices. When information is transferred or provided over a network or another communications connection (either hardwired, wireless, or a combination thereof) to a computer system, the computer system may view the connection as transmission media. The scope of computer-readable media includes combinations thereof.

Upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module and eventually transferred to computer system RAM and/or less volatile computer storage media at a computer system. Thus, computer storage media can be included in computer system components that also utilize transmission media.

Computer-executable instructions comprise, for example, instructions and data which when executed at a processor system, cause a general-purpose computer system, a special-purpose computer system, or a special-purpose processing device to perform a function or group of functions. In embodiments, computer-executable instructions comprise binaries, intermediate format instructions (e.g., assembly language), or source code. In embodiments, a processor system comprises one or more central processing units (CPUs), one or more graphics processing units (GPUs), one or more neural processing units (NPUs), and the like.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The operations of the methods described herein may be carried out in any suitable order, or simultaneously where appropriate. Additionally, individual blocks may be deleted from any of the methods without departing from the scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

Additionally, as used in this disclosure, phrases of the form “at least one of an A, a B, or a C,” “at least one of A, B, and C,” and the like, should be interpreted to select at least one from the group that comprises “A, B, and C.” Unless explicitly stated otherwise in connection with a particular instance in this disclosure, this manner of phrasing does not mean “at least one of A, at least one of B, and at least one of C.” As used in this disclosure, the example “at least one of an A, a B, or a C,” would cover any of the following selections: {A}, {B}, {C}, {A, B}, {A, C}, {B, C}, and {A, B, C}.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the scope of this specification.

What is claimed is:

1. A hollow core fiber launch tail for use in Optical Time Domain Reflectometry, OTDR, or Optical Frequency Domain Reflectometry, OFDR, measurements on hollow core fiber, the launch tail comprising:
a length of hollow core fiber, having a first end and a second end; and
coupling optics coupled to the first end of the length of hollow core fiber,
wherein voids in the length of hollow core fiber are filled with a known gas.

2. The hollow core fiber launch tail according to claim 1, wherein the known gas is nitrogen.

3. The hollow core fiber launch tail according to claim 1, wherein the known gas is argon.

4. The hollow core fiber launch tail according to claim 1, wherein the voids in the length of hollow core fiber are filled with the known gas at a pressure that equals or exceeds atmospheric pressure.

5. The hollow core fiber launch tail according to claim 1, wherein the coupling optics comprise low back reflection coupling optics.

6. The hollow core fiber launch tail according to claim 5, wherein the low back reflection coupling optics comprises an angled interface and an anti-reflective coating.

7. The hollow core fiber launch tail according to claim 1, wherein the hollow core fiber launch tail is coupled to an OTDR/OFDR device via the coupling optics.

8. The hollow core fiber launch tail according to claim 7, wherein a fiber under test comprises a second length of hollow core fiber and is coupled to the second end of the length of hollow core fiber in the hollow core fiber launch tail.

9. A method of characterizing a hollow core fiber using a hollow core fiber launch tail, the method comprising:
connecting the hollow core fiber to a second end of a length of hollow core fiber in the hollow core fiber launch tail, wherein an OTDR/OFDR device is coupled to the hollow core fiber launch tail via a low back reflection coupling optics in the hollow core fiber launch tail;
generating OTDR/OFDR results for the hollow core fiber launch tail and the hollow core fiber; and
characterizing the hollow core fiber by comparing a first portion of the OTDR/OFDR results to a second portion of the OTDR/OFDR results, wherein the first portion of the OTDR/OFDR results corresponds to back reflections from the hollow core fiber and the second portion of the OTDR/OFDR results corresponds to back reflections from the hollow core fiber launch tail.

10. The method according to claim 9, wherein the OTDR/OFDR device comprises an OTDR device and the OTDR/OFDR results comprise an OTDR trace.

11. The method according to claim 10, wherein comparing a first portion of the OTDR trace to a second portion of the OTDR trace comprises:
comparing a slope of the first portion of the OTDR trace to a slope of the second portion of the OTDR trace.

12. The method according to claim 9, wherein connecting the hollow core fiber to the second end of the length of hollow core fiber in the hollow core fiber launch tail comprises:
splicing the hollow core fiber to the second end of the length of hollow core fiber in the hollow core fiber launch tail.

13. The method according to claim 9, wherein the hollow core fiber launch tail comprises the length of hollow core fiber having a first end and the second end, and the low back reflection coupling optics coupled to the first end of the length of hollow core fiber, and wherein voids in the length of hollow core fiber are filled with a known gas.

14. A method of manufacturing a hollow core fiber launch tail, the method comprising:
cutting a length of hollow core fiber;
purging the length of hollow core fiber with a known gas;
allowing pressure of the known gas in the hollow core fiber to equalize with atmospheric pressure; and
forming coupling optics at a first end of the length of hollow core fiber.

15. The method according to claim 14, wherein the known gas is nitrogen or argon.

16. The method according to claim 15, wherein purging the length of hollow core fiber with the known gas comprises purging the length of hollow core fiber with the known gas to a pressure above atmospheric pressure.

17. The method according to claim 14, wherein the coupling optics comprise low back reflection coupling optics.

18. The method according to claim 17, wherein the low back reflection coupling optics comprises an angled interface and an anti-reflective coating.

19. The method according to claim 14, wherein the hollow core fiber launch tail is coupled to an OTDR/OFDR device via the coupling optics.

20. The method according to claim 19, wherein a fiber under test comprises a second length of hollow core fiber and is coupled to an end of the length of hollow core fiber in the hollow core fiber launch tail.
